(19) United States
(12) Patent Application Publication
(10) Pub. No.: US 2011/0131485 A1
(43) Pub. Date: Jun. 2, 2011

(54) PUBLISHING SPECIFIED CONTENT ON A WEBPAGE

(75) Inventors: Shenghua Bao, Beijing (CN); Ben Fei, Beijing (CN); Zhong Su, Beijing (CN); Xian Wu, Beijing (CN); Xiao Xun Zhang, Beijing (CN)

(73) Assignee: International Business Machines Corporation, Armonk, NY (US)

(21) Appl. No.: 12/944,053

(22) Filed: Nov. 11, 2010

(30) Foreign Application Priority Data
Nov. 30, 2009 (CN) 200910225832.2

(51) Int. Cl. G06F 17/00

(52) U.S. Cl. 715/243

(57) ABSTRACT

A method and system for publishing specified content on a webpage. Specifically, an example method for publishing specified content at a specified location of a webpage includes the steps of performing sentiment analysis upon context surrounding a specified location where the specified content is to be published to determine a sentiment tendency of the context surrounding the specified location and selecting whether or not to publish the specified content at the specified location according to the sentiment tendency of the context surrounding the specified location. Embodiments of the invention help to make the webpage content more coherent, make the contents of a webpage matching in sentiment and rational in layout, improve a viewer's feeling of the webpage content, and increase website click rate and revenue. Embodiments help achieve a beneficial effect of providing a web electronic ad matching the sentiment of a webpage.

### CROSS-REFERENCE TO RELATED APPLICATIONS

This application claims priority under 35 U.S.C. §119 to Chinese Patent Application No. 200910225832.2 filed Nov. 30, 2009, the entire text of which is specifically incorporated by reference herein.

### BACKGROUND OF THE INVENTION

Embodiments of the present invention generally relate to methods and systems for publishing specified content on a webpage, in particular for publishing specified content at a specified location of a webpage which matches sentiment of the context surrounding the specified location based on a sentiment analysis result on the webpage content. Specifically, embodiments of the present invention relate to publishing a web electronic advertisement at a specified location of a webpage which matches the sentiment of the context surrounding the specified location.

Internet or web based advertising is considered to be a form of promotion that uses the Internet and World Wide Web for the expressed purpose of delivering marketing messages to attract customers. Examples of online advertising include contextual advertisements (ads) on search engine results pages, banner ads, Rich Media Ads, online classified advertising, advertising networks and e-mail marketing etc.

### BRIEF SUMMARY

Example embodiments of the present invention are a method and device capable of publishing, at a specified location of a webpage, specified content matching the sentiment of the context surrounding the specified location based on sentiment analysis of the webpage content. More specifically, the present invention relates to a method and device for publishing, at a specified location of a webpage, a web electronic advertisement matching the sentiment of the context surrounding the specified location.

Additional example embodiments of the present invention disclose a system, a method and a computer program product of publishing specified content at a specified location of a webpage. An analyzing operation analyzes the context surrounding content at a specified location, preferably in terms of the sentiments around the content. A selecting operation selects whether or not to publish specified content at the specified location of the webpage based on the sentiment tendency determined of the context surrounding the specified location.

According to the example embodiments of the present invention, it is possible to publish specified content at a specified location matching the sentiment of the context surrounding the specified location based on a result of sentiment analysis on the webpage content, thereby making the webpage content more coherent, webpage layout more rational, improving a user's impression of the webpage content. Since it is possible to publish an advertisement at a specified location of a webpage matching the context surrounding the specified location based on a result of sentiment analysis of the webpage content, a more suitable advertisement can be presented on a webpage, which increases click rate of the web electronic advertisement or viewership of a webpage due to the advertisement, thereby increasing revenue.

### BRIEF DESCRIPTION OF THE SEVERAL VIEWS OF THE DRAWINGS

The figures form a part of the specification and are used to describe the embodiments of the invention and explain the principle of the invention together with the literal statement.

FIG. 1 schematically illustrates a webpage containing a “buyout-based” web electronic ad in the prior art;

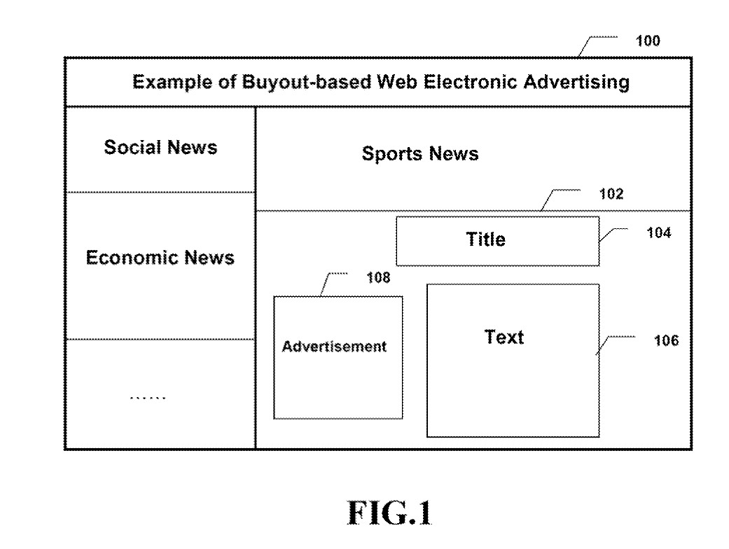

FIG. 2 schematically illustrates a webpage containing an Adwords web electronic ad provided by Google Company;

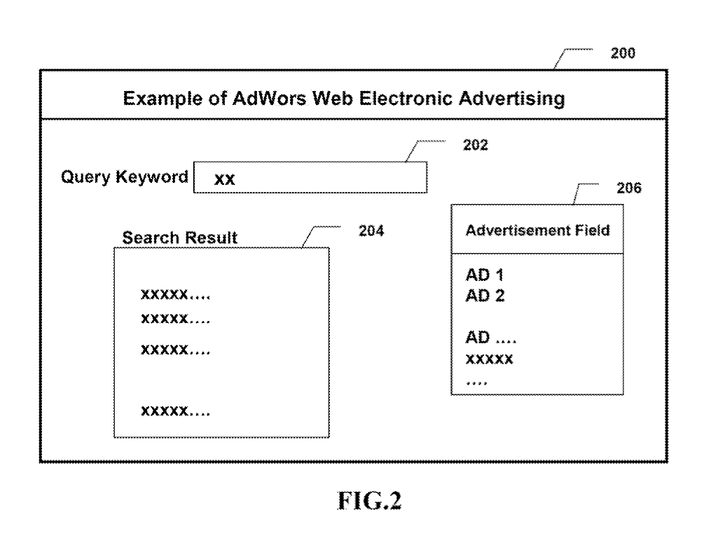

FIG. 3 schematically illustrates a webpage of an Adsense web electronic ad provided by Google Company.

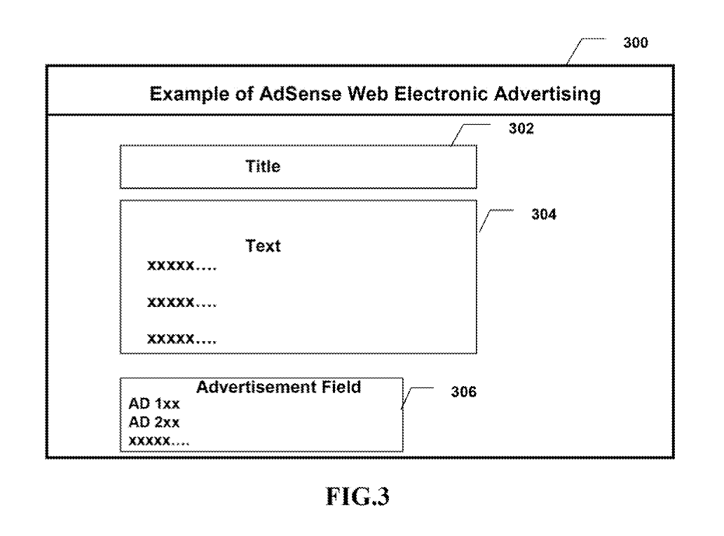

FIG. 4 is a schematic flow chart of a method for publishing, at a specific location of a webpage, specified content matching the context surrounding the specific location according to the present invention;

FIG. 5 is a schematic flow chart of sentiment analysis on a target webpage related to the specified content according to the present invention; and

FIG. 6 is a schematic structural diagram of a system for publishing, at a specified location of a webpage, specified content matching the context surrounding the specified location according to the present invention.

### DETAILED DESCRIPTION

It should be readily understood that the components of the embodiments as generally described herein and illustrated in the figures could be arranged and designed in a wide variety of different configurations. Thus, the following detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated. For example, though the embodiments of the present invention are described mainly directed to web electronic advertisement in a webpage of the Internet, this technology may be applied to other similar technical areas. Specifically, embodiment of the present invention may be applied where it is necessary to determine whether certain content should be displayed according to whether the sentiment attributes of the content matches with the sentiment tendency of the context. Therefore, though web electronic advertisements is used as an example to describe embodiments of the present invention, it should be understood by one skilled in the art that the embodiments presented herein may be widely applied to any other form of publishing content as well.

Embodiments of the present invention provide a new technical solution of publishing, at a specified location of a webpage, specified content matching the context surrounding the specified location based on the sentiment of the context surrounding the specified location. More specifically, embodiments of the present invention performs sentiment analysis of the context on the general content around a specified location to be published in a webpage and selectively publishes the specified content, such as a web electronic advertisement, based on the sentiment the context of the general content around a specific location.

In publishing, especially at a specified location of a webpage, specified content matching the context surrounding the specified location, a sentiment analysis is performed upon the context surrounding a specified location where specified content is to be published to determine a sentiment tendency of the context associated with content at a the specified location and then determining whether the specified content should be published at the specified location of the webpage based on the determined sentiment tendency of the context surrounding the specified location.

Consider as an exemplary embodiment, the “buyout-based” web electronic advertisement. When an advertiser buys out a specified location on a webpage of a certain website, the advertisement of the advertiser will be continuously displayed at that location for a predetermined period, and in this period, the advertisement is not changed no matter how the context surrounding the displayed advertisement changes. However, the inventor have noticed that, when the content of the context surrounding an advertisement has a negative impact on the advertiser or the advertisement itself (such as affecting the advertiser's social image), the advertiser would like to refrain from advertising under such occasion. Likewise, for the specified content published on a specified location of a webpage, if the content of the context surrounding the specified location is updated in real time while the specified content is not changed, the specified content may be emotionally contradictory or not matching with the updated context surrounding the specified location, thereby causing the webpage layout to appear irrational, and affects the viewing experiences for example by making the website less attractive to a viewer. For the above reasons and other reason which can impact a viewer's experience of viewing a webpage, embodiments of the present invention provides a technique of choosing whether to publish certain content on a webpage based on the sentiment analysis result of the webpage content. In other words, embodiments of the present invention provides a technique of choosing whether to publish a web electronic advertisement or temporarily update or cancel an unsuitable web electronic advertisement based on the sentiment analysis result on the webpage content as directed to the application circumstance of a web electronic advertisement.

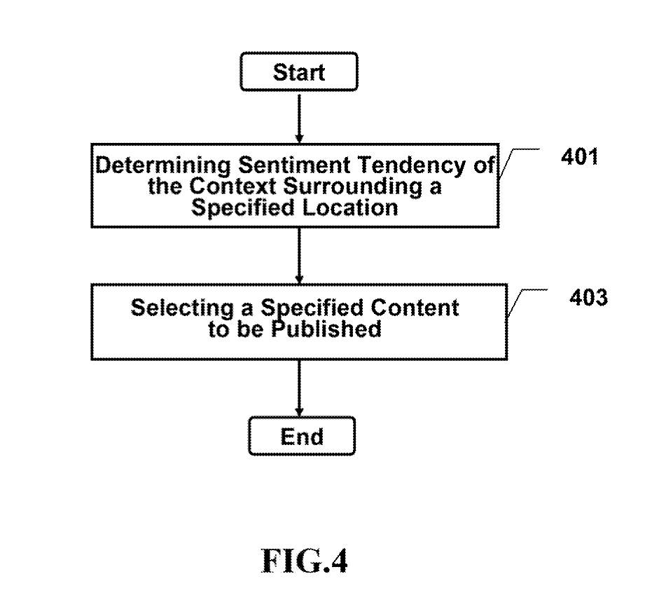

FIG. 4 is an exemplary embodiment of a flow chart of a method for publishing specified content at a specified location of a webpage. In step S401, sentiment analysis of the context around a specified location of a webpage, where specified content is to be published is performed, to determine a sentiment tendency of the context around the specified location. The sentiment tendency refers to that expressed by the content of the context around the specified location. For example, in one embodiment, the sentiment tendency refers to that of the context surrounding the specified location with respect to the specified content. The sentiment tendency can be determined to be falling into any one of the three categories positive, negative or neutral. Moreover, in one embodiment, determining the sentiment tendency of the context around the specified location further includes determining an emotion tendency of the context around the specified location or determining an emotion tendency of the context around the specified location with respect to the specified content, and further dividing the sentiment tendency into finer categories based on the emotion tendency determined. In one embodiment, the emotion tendency may be people's feelings with respect to the content of the context, including happiness, anger, sadness and joy, etc.

Specifically, according to embodiments of the present invention, it is possible to analyze the sentiment of the context around a specified location in a web page where a web electronic advertisement is to be published so as to determine the sentiment tendency of the context surrounding the web electronic advertisement.

In a further embodiment of the present invention, a sentiment tendency of the context around a specified location is determined with respect to the specified content. In the case of web electronic advertisements, determining a sentiment tendency of the context around a specified location is realized by publishing a web electronic advertisement with respect to the web electronic advertisement. For example, the sentiment tendency of the context surrounding the web electronic advertisement with respect to the advertisement is weighted and determined by analyzing the sentiment of the text around the web electronic advertisement in conjunction with information related to the sentiment attributes of the web electronic advertisement, such as the sentiment attributes of the advertiser or the advertisement itself.

For example, consider an airplane advertisement of XX airplane manufacturing company. If the context surrounding the “airplane advertisement of the XX airplane manufacturing company” becomes a news because “people distrust the quality of XX airplanes as air crashes constantly happened thereto”, then according to embodiments if the present invention, the sentiment of the news text is analyzed to determine that the sentiment tendency expressed by the news is “negative”, and the viewer may exhibit an emotion tendency of “sadness” with respect to the advertisement. Thereafter, by taking into account the published content, i.e. the published content and displayed advertisement (the airplane advertisement) as a weighting factor, it can be inferred that the news is related to the advertiser “XX airplane manufacturing company” and will have a negative impact on the XX airplane manufacturing company. Thus, it can be determined that the context around the airplane advertisement expresses a “negative” sentiment tendency with respect to the web electronic advertisement of the airplane manufacturing company.

According to a further embodiment of the present invention, determining the sentiment tendency of the context around a specified location can be performed on the basis of specified content to be newly published. For example, as for a new web electronic advertisement to be newly published, the sentiment tendency of the context around the specified webpage location where the new web electronic advertisement is to be published with respect to the advertiser of the advertisement may be determined first. In accordance with an exemplary embodiment of the present invention, the determination of the sentiment tendency of the context around a specified location may also be performed on the basis of specified content that has already been published. Specifically, for specified content already published, the sentiment tendency of the changed context around the specified location with respect to the published specified content is determined responsive to the change of the context around the specified location. For example, for a web electronic advertisement already published at a specified location of a webpage, after the context around the advertisement is changed, the sentiment tendency of the changed context surrounding the published advertisement with respect to the advertiser is determined after such a change is detected.

After determining the sentiment tendency of the context around the specified location, the method proceeds to step S403. At step S403, it is determined whether or not the specified content is to be published at the specified location of the webpage based on the sentiment tendency determined of the context around said specified location.

For example, after performing sentiment analysis on the context around the web electronic advertisement, it is determined whether the sentiment tendency of the context with respect to the web electronic advertisement is “positive” or “neutral”. Preferably, if people's feeling on the context with respect to the advertisement is determined as “happiness” or “joy”, the advertisement will continue to be displayed at the specified location of the webpage. On the contrary, if the sentiment tendency of the context with respect to the advertisement is determined as “negative”, the current advertisement will be replaced with a more suitable advertisement to be published on the current webpage, such as a public service advertisement, etc.

Accordingly, embodiments of the present invention provides a new technical solution capable of publishing, at a specified location of a webpage, specified content matching the sentiment of the context around the specified location, and in particular, publishing, at a specified location on a webpage, a web electronic advertisement matching the sentiment of the context around the specified location.

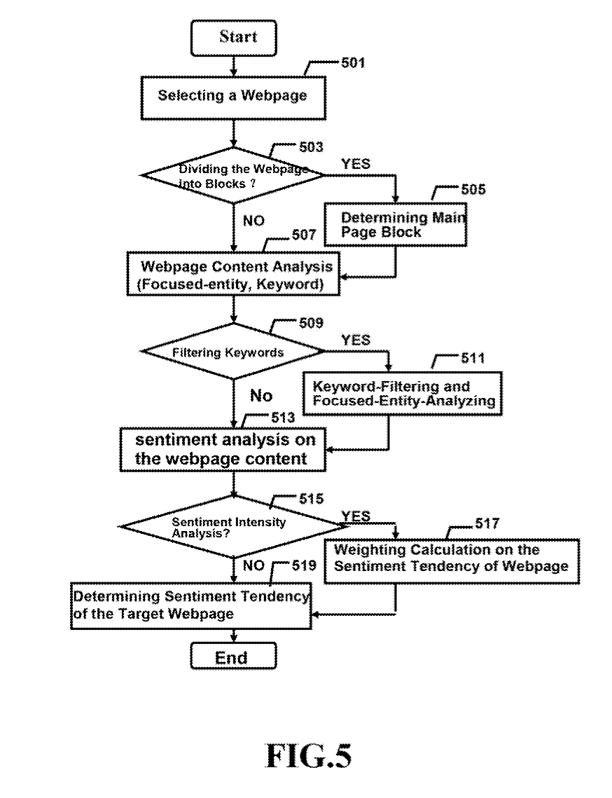

In the following, the flow chart of sentiment analysis as performed on a target webpage related to the specified content according to an exemplary embodiment of the present invention is described in detail with reference to FIG. 5.

For example, in one embodiment, sentiment may be taken as the basis for content classification and retrieval. Accordingly, it is possible to realize embodiments of the present invention by means of the techniques of sentiment analysis on content. Sentiment analysis techniques are mainly classified into two kinds: one is a sentiment-dictionary-matching based method and statistics-learning based method.

The sentiment-dictionary-matching based method establishes positive and negative sentiment dictionaries manually or semi-automatically. A document or a sentence can be simply classified into a positive or a negative sentiment by using such a sentiment dictionary. However, this sentiment-dictionary-matching based method cannot handle a newly appearing word in the document, and the creation of the sentiment dictionary needs considerable human and material resources. The statistics-learning based method attempts to use a machine-learning method to extract some linguistic features from an article or sentence, which usually include adjectives, adverbs and some linguistic models. These features can be used for training some sentiment classification models which are then applied to a new article to classify the sentiment tendencies. However, embodiments of the present invention adopt a focused entity analysis technique and a sentiment intensity weighting technique.

FIG. 5 is an exemplary embodiment of a flow chart schematically showing a sentiment analysis processing on a target webpage related to specified content. It should be noted that, FIG. 5, for example, uses a “buyout-based” web electronic advertisement to describe the sentiment analysis processing on a target webpage related to the specified content, but as can be understood, the sentiment analysis processing is also applicable to a “searching” web electronic advertisement.

At step S501, a target webpage for publishing specified content is selected. For content to be newly published, the target webpage is a webpage to publish the new content, and for the content already published, the target webpage refers to the current webpage where the content is located. In the case of web electronic advertisements, a target webpage for publishing a web electronic advertisement is selected. As for the “buyout-based” advertising, the target webpage for publishing an advertisement is fixed. It may be a webpage where an advertisement is to be published or the current webpage where the advertisement already published is located. As for the “content searching” advertising, the target webpage may be a webpage as retrieved by keyword query in a ADSENSE (is an advertisement serving application) advertising system or a result page of the keyword query in an ADWORDS advertising system. ADSENSE and ADWORDS are registered trademarks and applications of Google.

After a target webpage for publishing specified content is determined, it is possible to directly perform sentiment analysis on the target webpage determined, and the process proceeds to step S507. For example, as for the webpage whose layout or the content thereof is simple, the whole content of the target webpage can be analyzed directly. For a searched webpage where an ADSENSE advertisement is displayed, the sentiment of the webpage can also be analyzed directly.

When the target webpage has a complex layout or contain various contents, according to embodiments of the present invention, the method may include a step of dividing the webpage into blocks and finding out a main page block where the specified content is displayed, as shown in step S503. Alternatively, at step S503, if it is determined that the target webpage needs to be divided into blocks, the process proceeds to step S505 to find a main page block where a published content belongs to.

As understandable to a person skilled in the art, currently, most web pages are divided into blocks in visual distribution, each block containing its own subject matter. Accordingly, embodiments of the present invention utilizes a webpage-blocking technique to segment the content block (also called page block) where the published content is located from the webpage, and performs textual analysis only on the page block (the main page block) where the published content is located. The webpage content blocking technique is mainly a technique of dividing a webpage into a plurality of content-aggregated blocks with different sizes on the basis of a DOM (Document Object Model) tree structure of the webpage in combination with visual features of various elements in a DOM tree (such as length, width and whether there is a “table” separator, etc). Specifically, the DOM tree structure provides users with some logical structures by which it is possible to divide a webpage into frames, tables and paragraphs. Thus, the webpage blocking technique attempts to extract features of the logical structure of a webpage from the DOM tree. The webpage blocking technique also uses visual features of the webpage by extracting the length, width and area, etc, of each logical block, to classify the block as a horizontal-vertical shape or other shapes. Based on the two kinds of features, the webpage is divided into a plurality of modules which are logically cohered and naturally divided visually.

In the case of “buyout-based” web electronic advertisements, a page block where the published advertisement is located can be easily determined by means of the webpage blocking technique. Instead of analyzing all the texts in the target webpage where the published advertisement is located, only the text in the page block where the advertisement is located is analyzed. Therefore, the speed of analyzing is accelerated, and content irrelevant to the advertisement in the webpage or the advertiser is screened out (such as noise text or other advertisements appearing on the webpage).

At step S507, webpage content analysis is performed on the target webpage or a main page block in the target webpage. The webpage content analysis may include focused entity analysis, keyword analysis or a combination thereof. Based on the focused entity technique described in embodiments of the present invention, it is possible to automatically identify the main objects mentioned in an article or a text, such as people, place or company, etc., for example by using machine learning techniques. By means of the “focused entity technique”, embodiments of the present invention increases the accuracy of judging the sentiment tendency of the context around the specified location with respect to the specified content, and also increases the accuracy of finding more suitable specified content capable of being placed at this location. For a web electronic advertisement, the “focused entity technique” is more helpful in increasing the accuracy of finding a suitable advertiser object.

In the “focused entity technique” entity objects in a text are to be analyzed (i.e. the context around a specified location), which are extracted by means of named entity recognition. Thereafter, features of the entity objects, such as appearance rate, appearance location and its grammatical category in the context (such as “subject”, “predicate”, etc), are extracted. The features of the entity objects are used for training a focused entity classification technique so as to focus the entity objects to particular entity objects. In addition, focused entities may be extracted from absent sample.

The following describes the keyword analysis technique according to embodiments of the present invention. Usually, sentence-division is performed on the text of the target webpage or the text of a main page block therein, and keywords are extracted from each divided sentence. Accordingly, a plurality of keywords may be extracted from the context surrounding a specified location. When the extracted keywords are closely related to the specified content, processing proceeds to step S513 for performing sentiment analysis on the webpage content.

When the extracted keywords are too many or complicated, a keyword filtering may be performed on the extracted keywords. At this moment, after it is determined at step S509 that keyword filtering is necessary, the processing proceeds to step S511.

At step S511, a keyword filtering and/or focused entity analyzing is performed. According to one embodiment, keywords extracted from the context surrounding/around the specified location of the webpage are filtered on the basis of predetermined keywords related to the specified content so as to determine the specified content that may be suitable for the webpage. For example, the predetermined keywords related to the specified content may be those pre-set or pre-stored by the website. Further, the predetermined keywords related to the specified content may also be those related to a company name of the advertiser of the web electronic advertisement or the product or service as provided by the advertiser. Accordingly, it is possible to decide whether the content in the context surrounding/around the specified location is relevant to the ad to be put on the webpage.

As understandable to a person skilled in the art, if the extracted keywords are too many or complicated, a focused entity analyzing may be performed, and focus the content of the target webpage or the content of a main page block in the target webpage on particular entity objects. As understandable to a person skilled in the art, if the keywords extracted from the target webpage or a main page block therein is directly related to the content to be published, the process may directly proceed to a sentiment analysis on the webpage content without performing focused entity analyzing or keyword filtering on the webpage content.

At step S513, sentiment analysis on the content of the target webpage or the content of a main page block therein has commenced. As understandable to a person skilled in the art, in natural language processing, keyword extraction for webpage content mainly focuses on nouns or noun phrases in a text, and aims to extract some conceptual words as keywords. As also understandable to a person skilled in the art, besides conveying an explicit meaning, the text in the webpage content may also imply an implicit sentiment or emotion. On noticing such a trend, sentiment analysis is performed on some adjectives, adverbs, adjective phrases as well as phrases including emotion-loaded nouns, verbs etc., in the content of a text (i.e. the text of a target webpage or the text of a main page block therein) to further determine the sentiment tendency of the webpage content. The sentiment tendency of the webpage content can be determined by using machine language learning, or a preset sentiment corpus, or by combining machine language learning with a preset sentiment corpus. For example, according to embodiments of the present invention, sentiment analysis may be performed on the adjectives, adverbs or adjective phrases (such as air crash, mine accident, earthquake), etc, in the context surrounding/around specified content (such as an ad) to determine the sentiment tendency of the context of the webpage.

Furthermore, the determination of the sentiment tendency of webpage content may also include determination of an emotion tendency (as mentioned above). The determination of an emotion tendency on the webpage content can be for example a viewer's evaluation on the content in the context surrounding an advertisement in the case of “buyout-based” web electronic advertising.

In one embodiment the text as a whole is evaluated to determine whether it is positive, negative or neutral after the sentiment tendency of all the sentences is judged. In other words, the final result depends on the ratio of the number of positive sentences to negative sentences in the text. However, in accordance with embodiments of the present invention in many articles, certain positive or negative sentences may play a decisive role of changing the result of sentiment tendency of the text as a whole.

Accordingly, in order to improve the accuracy of sentiment tendency analysis of webpage content, embodiments of the present invention further adopts an optimized step of assigning weights to sentiment on a webpage text, forming/(resulting in) a kind of sentiment intensity. As noticed by the inventor, it is sometimes inadequate to merely classify sentiment into two categories, i.e. positive and negative, or three categories, i.e. positive, negative and neutral. Accordingly, the present invention further classifies sentiment analysis into finer-grained categories, for example five categories of best, good, medium, bad and worst, when creating a training corpus. It should be understood by one skilled in the art that these five parameters are exemplary in nature and should not be construed as limiting of this invention. Thereafter, the most distinct features in each category are extracted. By using these features, sentiment intensity analysis of a file or sentence is performed.

Now, the process proceeds to step S515. When it is determined at step S515 whether sentiment intensity is necessary, the process proceeds to step S517. At step S517, calculation of weights is performed to determine the sentiment tendency of the content text of a target webpage or of a main page block therein accurately. Preferably, according to an embodiment of the present invention, weights are determined for sentiment sentences at certain locations. For example, as for sentences appeared at the beginning or end of an article or sentences appeared at the beginning or end of a paragraph, they would have larger weight factor. An entity associated with the specified content (such as an advertiser) can also decide not to publish the content at the current webpage (such as advertising in the current webpage) whenever a sentence inappropriate for him (including the bearable extent and bearable number of sentences) appears in the current article.

Next at step S519, the sentiment tendency of the text in a target webpage or a main page block can be finally determined. Embodiments of the present invention provides for the following when the specified content is not suitable to be published on the current webpage:

1) to automatically analyze and find out other specified content suitable for the sentiment tendency of the current context surrounding/around a specified location on the basis of the determined sentiment tendency of the context surrounding the specified location;

2) to publish a content unrelated to the sentiment tendency of the context at the current specified location.

According to embodiments of the present invention, keywords extracted from the context surrounding an advertisement are focused on a range associated with the advertisement or advertiser so as to determine whether the context of the advertisement is related to the advertisement or advertiser. Moreover, by analyzing the sentiment of the context surrounding the advertisement, it is possible to determine the sentiment tendency of the context surrounding the advertisement with respect to the advertisement or advertiser, which realizes an enhanced emotion-driven advertising mechanism, whereby a more suitable advertiser can be selected and the accuracy of advertisement selection is improved.

Under practical circumstances of web electronic advertisements, it is firstly determined which advertiser-object a webpage might be suitable to by detecting the subject matter of the webpage and analyzing the sentiment thereof. Then, sentiment and emotion analysis is performed on the whole content of the webpage, especially the context of the advertiser-object, to judge whether the webpage is positive or negative information for the advertiser-object and whether a viewer shows an emotion of joy, happiness, disgust or anger at the webpage. Based on the sentiment and emotion information regarding the advertiser-object, it is determined whether the advertisement of the advertiser-object is suitable to be published. If the sentiment is positive and the emotion is joy or happiness, it is advantageous for the advertiser to advertise on this webpage, and if the sentiment is neutral, it is also probably advantageous for the advertiser to advertise on this webpage.

When it is determined that the current webpage is not suitable to publish an advertisement of the advertiser, a secondary advertisement object can be selected by the following ways.

1) If the advertiser-object is not suitable, the website may choose a competitor of the advertiser-object to advertise on the webpage.

2) The second way is to match the keywords defined by the advertiser: the advertiser can define certain keywords based on the characteristics and functions of their products, for example, the keywords defined by an airbag company may be “traffic accident” and/or “speeding”, and keywords defined by an insurance company may be “fire disaster” and/or “accidental death”, etc. By matching these keywords, it is possible to find some suitable advertisers to advertise in the negative news, and this occasion is helpful for the advertisers to improve their status and become an influencer in that space.

3) The third way is to automatically find out a possible secondary advertisement object by analyzing the sentiment on the negative content. For example, consider an air crash report. The result of sentiment analysis on the air crash report shows that the context of the report is “negative”, but after performing sentiment analysis, it is discovered that said report contains the description “the insurance company is paying for the losses quickly” which shows a “positive” sentiment tendency. Then, by performing keyword (subject matter) or focused entity analysis on the sentence of “the insurance company is paying for the losses quickly”, it is discovered that the entity object is “insurance”, so it is very suitable to advertise for some insurance companies in this occasion. Accordingly, some insurance companies can be extracted from the advertiser category as secondary advertisement objects. However, if the report precisely mentions “XX insurance company” (said insurance company is in the advertiser database), the XX insurance company can be directly selected as a secondary ad object by the focused entity technique; and

4) The fourth way is not advertising on this webpage at all or just to publish a public service advertisement.

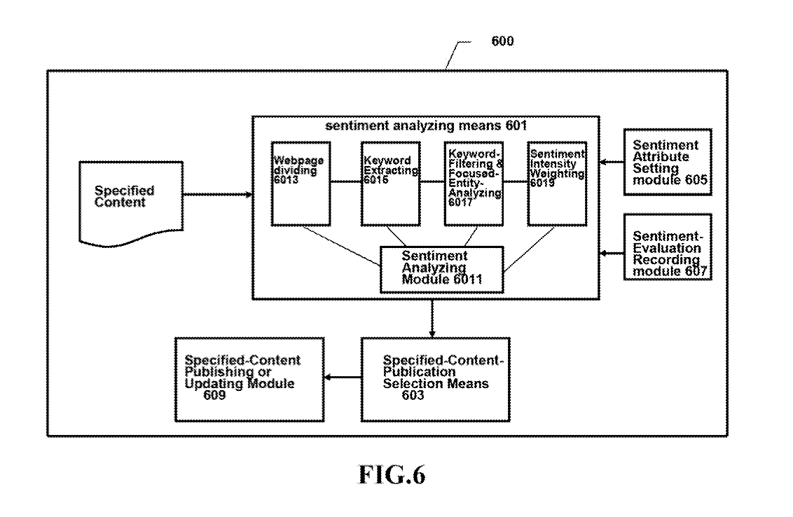

Reference is now made to FIG. 6 illustrating an exemplary embodiment of the system for publishing specified content at a specified location of a webpage as matching the context surrounding the specified location. FIG. 6 shows the system for publishing specified content at a specified location of a webpage as matching the context surrounding the specified location, which is capable of realizing the method disclosed previously. As illustrated in FIG. 6, the system 600 for publishing specified content at a specified location of a webpage comprises: a sentiment analyzing means 601 for performing sentiment analysis on the context surrounding the specified location where the specified content is to be published to determine a sentiment tendency of the context surrounding the specified location; and a specified-content-publication selection means 603 for selecting whether or not to publish the specified content at the specified location of the webpage based on the sentiment tendency of the context determined surrounding the specified location. Further, the system 600 includes a specified-content publishing or updating module 609 for publishing or updating the specified content on the webpage according to the selection result by the specified-content-publication selection means 603.

The sentiment analyzing means 601 includes a sentiment analyzing module 6011 for determining a sentiment tendency of the context surrounding the specified location with respect to the specified content, which includes any one of the following: positive, negative and neutral. Moreover, the sentiment analyzing module 6011 further includes a unit for determining an emotion tendency of the context surrounding the specified location with respect to the specified content (not shown). The emotion tendency includes any one of happiness, anger, sadness and joy, and is not limited to these.

The sentiment analyzing means 601 is also configured to re-determine, in response to a change of the context surrounding the specified location where the specified content has been published, a sentiment tendency of the changed context surrounding the specified location with respect to the published specified content. The sentiment analyzing means 601 further includes a keyword extracting module 6015 for extracting a plurality of keywords from the context surrounding the specified location; and a keyword-filtering and focused-entity-analyzing module 6017 for filtering the plurality of keywords extracted from the context surrounding the specified location on the basis of predetermined keywords which are associated with the specified content and extracted by the keyword extraction module 6015 so as to determine whether or not the webpage is associated with the specified content. The keyword-filtering and focused-entity-analyzing module 6017 is also adapted to extract entity objects from the context surrounding the specified location by means of named entity recognition technology, and perform features extraction upon an extracted entity object.

The sentiment analyzing means 601 also includes a webpage dividing module 6013 for dividing a webpage into a plurality of page blocks and for extracting a primary page block where the specified location is located, and the sentiment analyzing module 6011 determines a sentiment tendency of content of the primary page block extracted by the webpage dividing module 6013. The sentiment analyzing means 601 also includes a sentiment intensity weight assign module 6019 for assigning weights to sentences in different positions of the context surrounding the specified location, and the sentiment analyzing module 6011 calculates a sentiment tendency of the context surrounding the specified location based on sentiment sentences that are assigned weights in different positions as weighted by the sentiment intensity weight assigning module 6019.

The system 600 further includes a sentiment attribute setting module 605 for allowing an entity associated with the specified content to set sentiment attributes for the related specified content; and the sentiment analyzing means 601 determines a sentiment tendency of the context surrounding the specified location based on the sentiment attributes set for the specified content by the sentiment attribute setting module. The system 600 further includes a sentiment-evaluation recording module 607 for recording sentiment evaluations of content of the webpage where the specified location is located made by a plurality of viewers; and the sentiment analyzing means 601 determines a sentiment tendency of the context surrounding the specified location based on the sentiment evaluations made by the plurality of viewers as recorded by the sentiment-evaluation recording module.

According to an embodiment of the present invention, the specified content is a web electronic advertisement. According to an embodiment of the present invention, the web electronic advertisement is a “buyout-based” web electronic advertisement. According to an embodiment of the present invention, the web electronic advertisement is an “Adword” or “Adsense” electronic advertisement.

According to an embodiment of the present invention, the specified-content publication selection means 603 is further configured to automatically analyze and find out another specified content suitable for the sentiment tendency of the current context based on the determined sentiment tendency of the context surrounding the specified location.

As will be appreciated by those skilled in the art, the embodiments of the present invention can be embodied as a method, system or computer program product. Accordingly, embodiment of the present invention may take the form of an entirely hardware embodiment, an entirely software embodiment (including firmware, resident software, microcode, etc) or combination thereof. A typical embodiment of combining software and hardware is a general purpose computer system having a computer program, and when the program is loaded and executed, the computer system is controlled to execute the above method.

Embodiments of the present invention can be embedded in a computer program product, which have all the features for implementing the method as described above. The computer program product may be embodied in one or more computer-readable storage medium (including, but not limited to, a disk memory, a CD-ROM, an optical memory, etc) which has computer-readable program codes stored therein.

Embodiments of the present invention has been illustrated with reference to the flowcharts illustrations and/or block diagrams of methods, systems and computer program products according to embodiments of the present invention. Apparently, it will be understood that each block in the flowchart illustrations and/or block diagrams and combinations of blocks in the flowchart illustrations and/or block diagrams can be implemented by computer program instructions. These computer program instructions may be provided to a processor of a general purpose computer, special purpose computer, embedded processor or other programmable data processing apparatuses to produce a machine, such that the instructions, which execute via the computer or other programmable data processing apparatus, create means for implementing the functions/acts specified in the blocks of the flowchart illustrations and/or block diagrams.

The computer program instructions may also be stored in one or more computer-readable medium, each being capable of directing a computer or other programmable data processing apparatus to function in a particular manner, such that the instructions stored in the computer readable medium produce an article of manufacture including instruction means which implement the functions/acts described in one or more blocks of the flowchart illustrations and/or block diagrams.

The computer program instructions may also be loaded onto one or more computers or other programmable data processing apparatuses to cause a series of operational steps to be performed on the computers or other programmable data processing apparatuses thereby to produce a computer implemented process such that the instructions which execute on the computer or other programmable apparatus provide processes for implementing the functions/acts specified in the blocks of the flowchart illustrations and/or block diagrams.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The principles of the present invention have been explained with reference to the preferred embodiments of the present invention. However, the explanation is only exemplary, and shall not be understood as any limitation of the disclosure. A person skilled in the art may make any variation or modification of the present invention without deviating from the spirit and scope of the present invention as defined in the claims as attached.

That which is claimed is:

1. A method of publishing specified content at a specified location of a webpage, the method comprising:
performing sentiment analysis by at least one computer processor upon the context surrounding the specified location where specified content is to be published to determine a sentiment tendency of the context surrounding the specified location; and
selecting whether or not to publish the specified content at the specified location of the webpage based on the determined sentiment tendency of the context surrounding the specified location.

2. The method according to claim 1, wherein determining a sentiment tendency of the context surrounding a specified location includes determining a sentiment tendency of the context surrounding the specified location with respect to the specified content.

3. The method according to claim 2, wherein determining a sentiment tendency of the context surrounding the specified location with respect to the specified content further includes determining an emotion tendency of the context surrounding the specified location with respect to the specified content and dividing the sentiment tendency into finer-grained categories based on the determined emotion tendency.

4. The method according to claim 1, further comprising a step of re-determining, in response to a change of the context surrounding the specified location where the specified content has been published, a sentiment tendency of the changed context surrounding the specified location with respect to the published specified content.

5. The method according to any of claim 1, further comprising the steps of:
extracting a plurality of keywords from the context surrounding the specified location; and
filtering the plurality of keywords extracted from the context surrounding the specified location on the basis of predetermined keywords associated with the specified content so as to determine whether or not the webpage is associated with the specified content.

6. The method according to any of claims 1, further comprising:
extracting entity objects from the context surrounding the specified location by means of named entity recognition technology; and
extracting features from extracted entity objects.

7. The method according to any of claims 1, wherein the step of determining a sentiment tendency of the context surrounding a specified location includes:
dividing a webpage into a plurality of page blocks;
extracting a primary page block where the specified location is located; and
determining a sentiment tendency of content of the extracted primary page block.

8. The method according to any of claims 1, further comprising:
weighting sentiment sentences in different positions of the context surrounding the specified location to calculate a sentiment tendency of the context surrounding the specified location.

9. The method according to any of claims 1, further comprising:
determining a sentiment tendency of the context surrounding the specified location based on sentiment attributes set for related specified content by an entity associated with the specified content.

10. The method according to any of claims 1, further comprising:
recording sentiment evaluations of content of the webpage where the specified location is located as made by a plurality of viewers; and
determining a sentiment tendency of the context surrounding the specified location based on recorded sentiment evaluations made by the plurality of viewers.

11. The method according to any of claims 1, wherein the specified content is a web electronic advertisement.

12. The method according to any of claims 1, wherein, based on the determined sentiment tendency of the context surrounding the specified location, automatically analyzing and finding out another specified content suitable for the sentiment tendency of the current context.

13. A system for publishing specified content at a specified location of a webpage, the system comprising:
a non-transient computer-readable storage medium storing therein:
sentiment analyzing instructions for performing sentiment analysis upon the context surrounding the specified location where the specified content is to be published to determine a sentiment tendency of the context surrounding the specified location; and
specified-content-publication selecting instructions for selecting whether or not to publish the specified content at the specified location of the webpage based on the determined sentiment tendency of the context surrounding the specified location.

14. The system according to claim 13, wherein the sentiment analyzing instructions include sentiment tendency instructions for determining a sentiment tendency of the context surrounding the specified location with respect to the specified content.

15. The system according to claim 14, wherein the sentiment tendency instructions further include instructions for determining an emotion tendency of the context surrounding the specified location with respect to the specified content and dividing the sentiment tendency into finer-grained categories based on the determined emotion tendency.

16. The system according to claim 13, wherein the sentiment analyzing instructions include re-determining instructions to re-determine, in response to a change of the context surrounding the specified location where the specified content has been published, a sentiment tendency of the changed context surrounding the specified location with respect to the published specified content.

17. The system according to claim 13, wherein the sentiment analyzing instructions further comprise:
keyword extracting instructions for extracting a plurality of keywords from the context surrounding the specified location; and
keyword-filtering and focused-entity-analyzing instructions for filtering the plurality of keywords extracted from the context surrounding the specified location on the basis of predetermined keywords which are associated with the specified content and extracted by the keyword extraction module so as to determine whether or not the webpage is associated with the specified content.

18. The system according to claim 13, wherein the sentiment analyzing instructions further comprise:
keyword-filtering and focused-entity-analyzing instructions for extracting entity objects from the context surrounding the specified location by means of named entity recognition technology; and for extracting features from extracted entity objects.

19. The system according to claim 13, wherein the sentiment analyzing instructions further comprise:
webpage dividing instructions for dividing a webpage into a plurality of page blocks and for extracting a primary page block where the specified location is located; and
wherein the sentiment analyzing instructions determine a sentiment tendency of content of the primary page block extracted by the webpage dividing module.

20. The system according to claim 13, wherein the sentiment analyzing instructions further comprise:
sentiment intensity weighting instructions for weighting sentiment sentences in different positions of the context surrounding the specified location; and
wherein the sentiment analyzing instructions calculate a sentiment tendency of the context surrounding the specified location based on weighted sentiment sentences in different positions as weighted by the sentiment intensity weighting module.

21. The system according to claim 13, further comprising:
sentiment attribute setting instructions for allowing an entity associated with the specified content to set sentiment attributes for related specified content; and
wherein the sentiment analyzing instructions determine a sentiment tendency of the context surrounding the specified location based on the sentiment attributes set for the specified content by the sentiment attribute setting module.

22. The system according to claim 13, further comprising:
sentiment-evaluation recording instructions for recording sentiment evaluations of content of the webpage where the specified location is located made by a plurality of viewers; and
wherein the sentiment analyzing instructions determine a sentiment tendency of the context surrounding the specified location based on the sentiment evaluations made by the plurality of viewers as recorded by the sentiment-evaluation recording module.

23. The system according to claim 13, wherein the specified content is a web electronic advertisement.

24. The system according to claim 13, wherein the specified-content-publication selection instructions are further configured to automatically analyze and find out another specified content suitable for the sentiment tendency of the current context based on the determined sentiment tendency of the context surrounding the specified location.
